(19) United States
(12) Patent Application Publication
(10) Pub. No.: US 2026/0084989 A1
(43) Pub. Date: Mar. 26, 2026

(54) WATER CLARIFICATION CHEMICAL CONTROL SYSTEM

(71) Applicant: HALLIBURTON ENERGY SERVICES, INC, Houston, TX (US)

(72) Inventors: Stanislav BARSKOV, Houston, TX (US); Timothy OUBRE, Houston, TX (US)

(73) Assignee: HALLIBURTON ENERGY SERVICES, INC, Houston, TX (US)

(21) Appl. No.: 18/892,112

(22) Filed: Sep. 20, 2024

(51) Int. Cl. C02F 1/52

(52) U.S. Cl. CPC C02F 1/5209; C02F 1/5281; C02F 2209/01

(57) ABSTRACT

Water clarification systems and methods of clarifying water. An example system uses a water clarifier comprising a settling tank with a sample port disposed in a wall of the settling tank from and configured to allow for the removal of a sludge sample from the settling tank. The system additionally has a fluid characterization unit fluidically coupled to the sample port and a controller coupled to the fluid characterization unit. A chemical additive pump is coupled to the controller and the water clarifier. A sludge sample is obtained from the settling tank of a water clarifier and the density of the sludge sample is measured. A volume of a chemical additive is adjusted and it is introduced into the water clarifier based at least in part on the measured density of the sludge sample.

### TECHNICAL FIELD

The present disclosure relates generally to water clarification systems, and more particularly, to a water clarification system that couples a fluid characterization unit to a water clarifier to measure the density of a sludge bed and then introduce a chemical additive based on the measured density.

### BACKGROUND

Water clarifiers are used to purify water through the removal of solids. Solids may be removed through their deposition within a settling tank of the water clarifier. The settled solids form a sludge bed which retains the solids from the influent water and is used to filter out solids for water clarification and subsequent collection. In order to remove the solids from the influent water, the sludge bed should maintain a desired density and height. Chemical additives may be added to maintain the density and height of the sludge bed. Should the sludge bed become too dense or too thin, it may not adequately filter solids from the influent.

The influent water can change based on seasonal variation and other factors. The flowrate, water density, suspended solids, and type of organic matter can change which may result in detrimental effects to the sludge bed. The use of water clarifier systems may be an important part of a water clarification operation. The present disclosure provides improved water clarification systems for measuring the density of a sludge bed and then introducing a chemical additive based on the measured density so as to maintain a consistent sludge bed in the water clarifier.

### BRIEF DESCRIPTION OF THE DRAWINGS

Illustrative examples of the present disclosure are described in detail below with reference to the attached drawing figures, which are incorporated by reference herein, and wherein:

FIG. 1 is a schematic of a simplified water clarifier in accordance with one or more examples described herein; and

FIG. 2 is a diagrammatic illustration of a water clarification system for monitoring and regulating the properties of a sludge bed in a water clarifier in accordance with one or more examples described herein.

The illustrated figures are only exemplary and are not intended to assert or imply any limitation with regard to the environment, architecture, design, or process in which different examples may be implemented.

### DETAILED DESCRIPTION

The present disclosure relates generally to water clarification systems, and more particularly, to a water clarification system that couples a fluid characterization unit to a water clarifier to measure the density of a sludge bed and then introduce a chemical additive based on the measured density.

In the following detailed description of several illustrative examples, reference is made to the accompanying drawings that form a part hereof, and in which is shown by way of illustration specific examples that may be practiced. These examples are described in sufficient detail to enable those skilled in the art to practice them, and it is to be understood that other examples may be utilized, and that logical structural, mechanical, electrical, and chemical changes may be made without departing from the spirit or scope of the disclosed examples. To avoid detail not necessary to enable those skilled in the art to practice the examples described herein, the description may omit certain information known to those skilled in the art. The following detailed description is, therefore, not to be taken in a limiting sense, and the scope of the illustrative examples are defined only by the appended claims.

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by the examples of the present disclosure. At the very least, and not as an attempt to limit the application of the doctrine of equivalents to the scope of the claim, each numerical parameter should at least be construed in light of the number of reported significant digits and by applying ordinary rounding techniques. It should be noted that when “about” is at the beginning of a numerical list, “about” modifies each number of the numerical list. Further, in some numerical listings of ranges some lower limits listed may be greater than some upper limits listed. One skilled in the art will recognize that the selected subset will require the selection of an upper limit in excess of the selected lower limit.

In the following discussion and in the claims, the terms “including” and “comprising” are used in an open-ended fashion, and thus should be interpreted to mean “including, but not limited to.” Unless otherwise indicated, as used throughout this document, “or” does not require mutual exclusivity.

The terms “uphole” and “downhole” may be used to refer to the location of various components relative to the bottom or end of a well. For example, a first component described as uphole from a second component may be further away from the end of the well than the second component. Similarly, a first component described as being downhole from a second component may be located closer to the end of the well than the second component.

The terms “upstream” and “downstream” may be used to refer to the location of various components relative to one another in regards to the flow of a sample through said components. For example, a first component described as upstream from a second component will encounter a sample before the downstream second component encounters the sample. Similarly, a first component described as being downstream from a second component will encounter the sample after the upstream second component encounters the sample.

The present disclosure relates generally to water clarification systems that couple a fluid characterization unit to a water clarifier to measure the density of a sludge bed disposed within the water clarifier. The measured density is used to calculate and adjust the dispersal of a chemical additive to the water clarifier to adjust the properties of the sludge bed. Advantageously, the water clarification system allows for the continued monitoring and maintenance of a sludge bed without the need to perform settling tests. As a further advantage, the monitoring and maintenance may be automated. As such, the appropriate species and volume of chemical additive may be added without operator input to help ensure that the sludge bed possesses a desired density and thickness. This automated operation may maintain adequate solids removal and filtration in the associated water clarifier during seasonal shifts and adapt to seasonal variation in the water source. For example, the water clarification system may be used to adapt and adjust water systems to seasonal variations due to changes in flowrates, water density, type and concentration of suspended solids, and changes in the type and concentration of organic matter in the water supply. Moreover, the system components disclosed herein may be used with a variety of water clarifiers such as water reaction clarifiers, solids contact clarifiers, precipitator clarifiers, lamella water clarifiers, and pulsator water clarifiers. Further, the system components may be used to disperse a variety of chemical additives at a desired volume and rate to maintain sludge bed density, thickness, and height in the settling tank of the water clarifier. Advantageously, the water clarification system utilizes a Coriolis meter or refractometer to measure the density of the sludge bed and the system may be configured to allow for the measurement of the sludge bed density at different levels so as to obtain measurements of the sludge bed throughout its height. In addition, the water clarification system may reduce filter backwash frequency and increase filter service life. Moreover, the water clarification system may reduce the carryover of solids to downstream equipment such as ion exchange trains, filter membranes, cooling water exchangers, etc. This reduction may also result in a reduction in fouling of and an increase in service life of ion exchange media, membranes, cooling water exchangers, etc. Under certain conditions, the water clarification system may also reduce the chemical demand of a water clarifier.

The water clarification system may be adapted to be used with any water clarifier including, but not limited to, reaction clarifiers, solids contact clarifiers, precipitator clarifiers, lamella water clarifiers, pulsator water clarifiers, etc. The water clarification system may be used to clarify any type of water, including but not limited to, surface water, ground water, seawater, saturated seawater, brines, brackish water, geothermal water, etc. The water clarification system uses a water clarifier having a sludge bed to trap and remove particulates. Chemical additives such as coagulants and flocculants may induce suspended solids within the water supply to clump together into larger aggregates which may settle to become part of the sludge bed. In order to provide sufficient clarification, the density, thickness, and the height of the sludge bed should be controlled. The chemical additives maintain these sludge bed properties. Misuse of the chemical additives may result in the sludge bed becoming too thick or too thin. As such, careful monitoring and regulation of the sludge bed through the appropriate dosing of chemical additives is desirable.

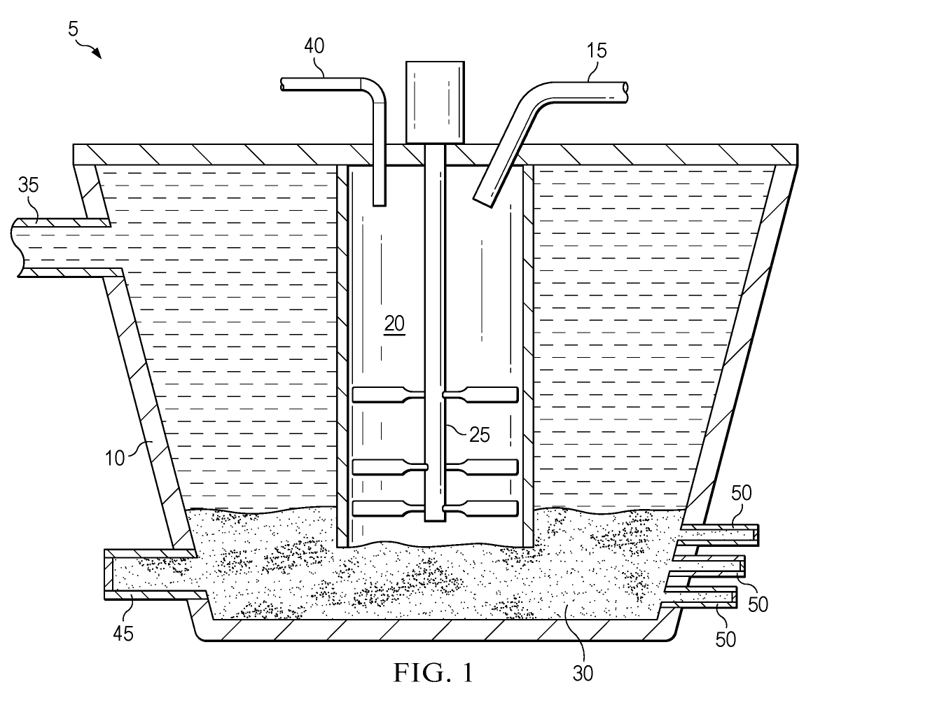

FIG. 1 is a schematic of a simplified water clarifier 5 in accordance with one or more examples described herein. The example water clarifier 5 comprises a settling tank 10 in which water from a water supply is introduced and clarified. The water is introduced via an influent port 15. Upon entering the water clarifier 5, the water is pumped through a mixing zone 20 in which the water may be mixed by an agitator 25. The agitator 25 may be any type of agitating mechanism including any type of mixing bar, rotor, impeller, and the like. The water is then pumped through the mixing zone 20 to the bottom of the settling tank 10 and through the sludge bed 30 disposed on the bottom of the settling tank 10. The sludge bed 30 is a large bed of aggregated solids that have been removed from the influent water as it is pumped through the water clarifier 5. These solids settle into the sludge bed 30 as they form large aggregates or may be filtered out of the influent water as the water passes through the sludge bed 30. The clarified water may then exit the water clarifier 5 via the effluent port 35 disposed above the sludge bed 30. Chemical additives, such as coagulants and/or flocculants, may be added to the water clarifier 5 from the chemical feed 40. The chemical feed 40 introduces the chemical additives into the mixing zone 20 so that they may mix with the influent water. The chemical additives may assist in aggregating the suspended solids so that they settle into or are filtered by the sludge bed 30. A sludge blowdown conduit 45 is used to remove sludge from the sludge bed 30. If the sludge bed 30 becomes too thick or too tall, the excess is removed through the sludge blowdown conduit 45. Sample ports 50 are connecting conduits positioned through the walls of the settling tank 10. The sample ports 50 are positioned to allow for the removal of a sludge sample from the sludge bed 30. Although three sample ports 50 are illustrated, it is to be understood that any number of sample ports 50 may be used including one, two, three, four, five, or more sample ports 50. If multiple sample ports 50 are used, the sample ports 50 may be arranged vertically within the wall of the settling tank 10 so as to allow for the removal of sludge samples from different heights of the sludge bed 30. As such, these differing height sample ports 50 allow for the determination of sludge bed density at different heights of the sludge bed 30. For example, the bottom, middle, and/or top level of sludge bed density may be measured. The density and consistency of the sludge bed 30 may thus be determined at multiple heights of the sludge bed 30 allowing for the health of the sludge bed 30 to be determined throughout the entirety of the sludge bed 30.

It should be clearly understood that the example system illustrated by FIG. 1 is merely a general application of the principles of this disclosure in practice, and a wide variety of other examples are possible. Therefore, the scope of this disclosure is not limited in any manner to the details of FIG. 1 as described herein.

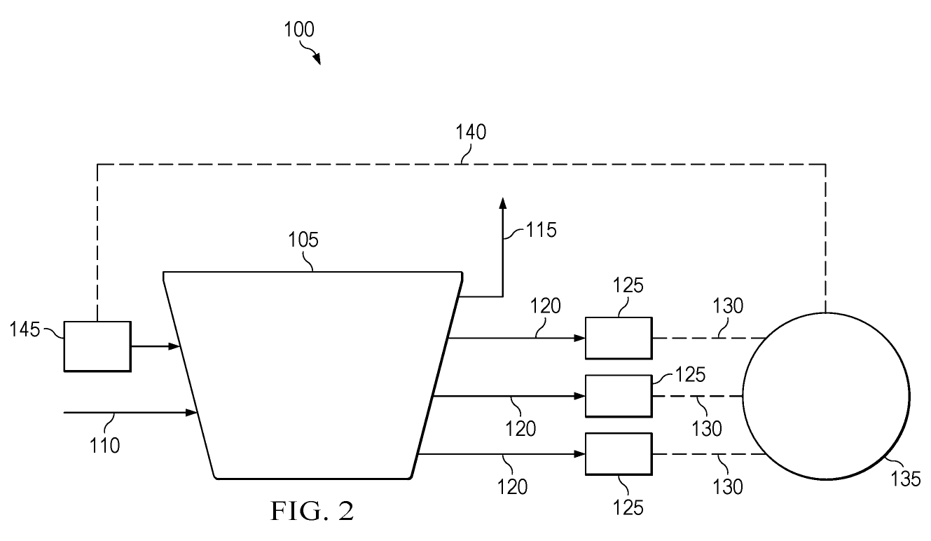

The FIG. 2 is diagrammatic illustration of a water clarification system 100 for monitoring and regulating the properties of a sludge bed in a water clarifier 105. As discussed above, water clarifiers, such as water clarifier 105, may clarify water by passing the water through a sludge bed which may assist in removing solids from the water. This process also revolves around adding chemical additives to assist in aggregating suspended solids into sizes that may settle into the sludge bed as well maintaining the sludge bed at a sufficient consistency and density. As illustrated in FIG. 2, water supply stream 110 supplies water from a water source to the water clarifier 105. Although not illustrated in FIG. 2, there may be mixing equipment and/or pumping equipment upstream to assist in conveying the water to the influent inlet of the water clarifier 105.

In the water clarifier 105, water is mixed in a mixing zone of a settling tank with a chemical additive and then pumped through a settled sludge bed to a location vertically higher than the sludge bed where the water exits from the water clarifier 105 via an effluent stream 115. The clarified water may then be used as needed or may be transferred to additional downstream equipment such as distillation equipment, wastewater processing equipment, or other equipment configured to process the content of the effluent water.

The water clarifier 105 includes at least one sample port 120 so that sludge samples can be drawn from the sludge bed disposed within the water clarifier 105. In this specific example, three sample ports 120 are placed in different vertical locations in the water clarifier 105 so that samples from different vertical locations of the sludge bed may be withdrawn from the water clarifier 105. Any number of sample ports 120 may be disposed on water clarifier 105 at any point, preferably at different vertical locations such that fluid samples can be drawn from different heights of the sludge bed. The sample ports 120 are disposed in the wall of the settling tank and are locations for sludge sample removal. The sample ports 120 may comprise conduits or lines (e.g., try lines), valves, taps, or other equipment sufficient for penetrating the settling tank of the water clarifier 105 and extracting a sample from the sludge bed within.

Each of the sample ports 120 are in fluid communication with sludge from the settling tank of the water clarifier 105 and also with one or more fluid characterization units 125. In some examples, multiple sample ports 120 may be in fluid communication with the same fluid characterization unit 125. In other examples, an individual sample port 120 may be in fluid communication with an individual fluid characterization unit 125. Each individual fluid characterization unit 125 may include a Coriolis meter or refractometer that analyzes the density of the obtained sludge sample and outputs a signal 130 corresponding to a measured density of the sampled sludge. The signal 130 may be any kind of signal transferred by any means such as a wireless signal or a wired signal, for example. The signal 130 may contain a result of the measurement made by the fluid characterization unit 125 such as a raw, unprocessed signal, or may contain the result of a measurement value that has undergone additional processing or calculation. The signal 130 is output from a fluid characterization units 125 to a controller 135. The fluid characterization units 125 may provide continuous measurement or may measure the incoming sludge samples at timed intervals. The fluid characterization units 125 may output the signal 130 to the controller 135 immediately or may output the signal at desired intervals.

Controller 135 receives signal 130 as an input and then outputs a second signal 140 to a chemical additive pump 145 to control the release of a chemical additive. The controller 135 may measure the density of the sludge bed and then increase or decrease the chemical dosage accordingly. To determine the appropriate chemical dosage, the controller 135 takes into account the flowrate of the untreated water. For example, if the chemical feed rate under normal operating conditions is 1 ppm (parts per million) and the controller 135 determines that the sludge bed is too thin, the controller 135 will send a signal to the chemical additive pump 145 to increase the chemical feed rate to a higher value, such as 1.5 ppm, until the desired density of the sludge bed is achieved. The controller 135 is configured to increase or decrease the volume of chemical additive based on the sludge bed density measurement signal. In some examples, controller 135 may calculate the volume of chemical additive to release by comparing the measured density value of the sludge sample to a reference table or calibration curve. In some other examples, controller 135 may utilize a predictive model to determine an amount of chemical additive to release. The predictive model may include functions to estimate the effect on the sludge bed of adding a volume of a chemical additive to the water clarifier 105 and/or directly to the water supply stream 110. The second signal 140 may be used to signal the release of a specific volume of chemical additive from the chemical additive pump 145 and/or may be used to regulate the flow rate of the released chemical additive from the chemical additive pump 145. In some examples, there may be multiple chemical additive pumps 145 which are configured to release different species of chemical additives such that flow controller 135 may select one or more chemical additives to add to the water clarifier 105 and/or directly to the water supply stream 110. In some examples, the controller 135 is configurable to determine the volume of chemical additive and to output the corresponding second signal to the chemical additive pump automatically and without operator input. In a specific example, the controller 135 is a three term controller such as a proportional-integral-derivative controller (PID controller).

As discussed above, the chemical additive pump 145 releases a chemical additive into the water clarifier 105. Although not illustrated, in some optional examples, the chemical additive pump 145 may instead release the chemical additive directly into the water supply stream 110. In some optional examples, the chemical additive pump 145 may release a chemical additive into both the water clarifier 105 and the water supply stream 110.

The chemical additive may be any suitable chemical additive for causing a desired effect in the sludge bed. The chemical additive may be used to adjust the density, thickness, and/or consistency of the sludge bed in the settling tank of the water clarifier 105. For example, the chemical additive may thicken the sludge bed if the measured density of the sludge sample indicates that the sludge bed is too thin. In some examples, the chemical additive is a flocculant or coagulant. Coagulants may affect the sludge bed by neutralizing the charges of the dispersed particulate solids thereby allowing them to agglomerate into larger particulate clumps. Flocculants may assist with the combining of already agglomerated particulate into larger particulates, thereby increasing their density and their probability of settling. Specific examples of the chemical additive may include, but are not limited to, aluminum chlorohydrate, polyaluminum chloride, epichlorohydrin, polydiallyldimethylammonium chloride, sodium aluminate, ferric chloride, ferric sulfate, aluminum chloride, aluminum sulfate anionic polyacrylamide, cationic polyacrylamide, or any combination of chemical additives. In some examples, there may be multiple chemical additive pumps 145 which may be fluidically coupled to sources of chemical additives such as tanks or totes to provide any combination of chemical additives as determined by controller 135. In these examples, the controller 135 may be configured to select any species of chemical additive based on the density reading of the sludge sample and, via the second signal 140, may induce the release of one or more species of chemical additives via one or more chemical additive pumps 145. These chemical additive pumps 145 may release a desired concentration of the one or more species of chemical additives as determined by the controller 135.

It should be clearly understood that the example system illustrated by FIG. 2 is merely a general application of the principles of this disclosure in practice, and a wide variety of other examples are possible. Therefore, the scope of this disclosure is not limited in any manner to the details of FIG. 2 as described herein.

The water clarification systems disclosed herein may directly or indirectly affect one or more components or pieces of equipment associated with or which may come into contact with the water clarification systems such as, but not limited to, wellbore casing, wellbore liner, completion string, insert strings, drill string, coiled tubing, slickline, wireline, drill pipe, drill collars, mud motors, downhole motors and/or pumps, cement pumps, surface-mounted motors and/or pumps, centralizers, turbolizers, scratchers, floats (e.g., shoes, collars, valves, etc.), logging tools and related telemetry equipment, actuators (e.g., electromechanical devices, hydromechanical devices, etc.), sliding sleeves, production sleeves, plugs, screens, filters, flow control devices (e.g., inflow control devices, autonomous inflow control devices, outflow control devices, etc.), couplings (e.g., electro-hydraulic wet connect, dry connect, inductive coupler, etc.), control lines (e.g., electrical, fiber optic, hydraulic, etc.), surveillance lines, drill bits and reamers, sensors or distributed sensors, downhole heat exchangers, valves and corresponding actuation devices, tool seals, packers, cement plugs, bridge plugs, and other wellbore isolation devices, or components, and the like.

Provided are systems for clarifying water in accordance with the disclosure and the illustrated FIGs. An example system comprises: a water clarifier comprising a settling tank; a sample port disposed in a wall of the settling tank and configured to allow for the removal of a sludge sample from the settling tank; a fluid characterization unit fluidically coupled to the sample port; a controller coupled to the fluid characterization unit; and a chemical additive pump coupled to the controller and the water clarifier.

Additionally or alternatively, the systems may include one or more of the following features individually or in combination. The fluid characterization unit may comprise a Coriolis meter or a refractometer. The settling tank may comprise a plurality of sample ports arranged vertically through the wall of the settling tank. The plurality of sample ports may be configured to remove a sludge sample from a different height of a sludge bed disposed in the settling tank. The system may further comprise at least one fluid characterization unit; wherein each individual sample port is fluidically coupled to at least one fluid characterization unit. The fluid characterization unit may be configured to measure a density of the sludge sample removed from the sample port. The fluid characterization unit may output a signal corresponding to the measured density of the sludge sample to the controller. The controller may be configurable to receive the output signal from the fluid characterization unit and then output a second signal to the chemical additive pump. The chemical additive pump may be configurable to receive the second signal from the controller and to introduce a chemical additive into the water clarifier; wherein a volume of the introduced chemical additive is determined by the controller. The controller may be configurable to determine the volume of the introduced chemical additive using a reference table or calibration curve based in part on the measured density of the sludge sample. The controller may be configurable to determine the volume of chemical additive and to output the corresponding second signal to the chemical additive pump automatically and without operator input. The chemical additive may comprise aluminum chlorohydrate, polyaluminum chloride, epichlorohydrin, polydiallyldimethylammonium chloride, sodium aluminate, ferric chloride, ferric sulfate, aluminum chloride, aluminum sulfate anionic polyacrylamide, cationic polyacrylamide, or a combination of chemical additives. The controller may be a proportional–integral–derivative controller (PID). The system may further comprise a plurality of chemical additive pumps each configurable to introduce a different species of chemical additive into the water clarifier.

Provided are methods for clarifying water in accordance with the disclosure and the illustrated FIGs. An example method comprises obtaining a sludge sample from a settling tank of a water clarifier, measuring a density of the sludge sample, and adjusting a volume of a chemical additive introduced into the water clarifier based at least in part on the measured density of the sludge sample.

Additionally or alternatively, the method may include one or more of the following features individually or in combination. The fluid characterization unit may comprise a Coriolis meter or a refractometer. The settling tank may comprise a plurality of sample ports arranged vertically through the wall of the settling tank. The plurality of sample ports may be configured to remove a sludge sample from a different height of a sludge bed disposed in the settling tank. At least one fluid characterization unit may be included; wherein each individual sample port is fluidically coupled to at least one fluid characterization unit. The fluid characterization unit may be configured to measure a density of the sludge sample removed from the sample port. The fluid characterization unit may output a signal corresponding to the measured density of the sludge sample to the controller. The controller may be configurable to receive the output signal from the fluid characterization unit and then output a second signal to the chemical additive pump. The chemical additive pump may be configurable to receive the second signal from the controller and to introduce a chemical additive into the water clarifier; wherein a volume of the introduced chemical additive is determined by the controller. The controller may be configurable to determine the volume of the introduced chemical additive using a reference table or calibration curve based in part on the measured density of the sludge sample. The controller may be configurable to determine the volume of chemical additive and to output the corresponding second signal to the chemical additive pump automatically and without operator input. The chemical additive may comprise aluminum chlorohydrate, polyaluminum chloride, epichlorohydrin, polydiallyldimethylammonium chloride, sodium aluminate, ferric chloride, ferric sulfate, aluminum chloride, aluminum sulfate anionic polyacrylamide, cationic polyacrylamide, or a combination of chemical additives. The controller may be a proportional–integral–derivative controller (PID). The system may further comprise a plurality of chemical additive pumps each configurable to introduce a different species of chemical additive into the water clarifier. The density may be measured with a Criolis meter or a refractometer. The Coriolis meter or a refractometer outputs a signal to a controller coupled to a chemical additive pump which introduces the chemical additive into the water clarifier. The method further comprises configuring the controller to determine the volume of the introduced chemical additive using a reference table or calibration curve based in part on the measured density of the sludge sample. The method further comprises configuring the controller to determine the volume of chemical additive and to output a signal to the chemical additive pump automatically and without operator input. The introduced chemical additive adjusts a density of a sludge bed disposed in the settling tank.

The preceding description provides various examples of the systems and methods of use disclosed herein which may contain different method steps and alternative combinations of components. It should be understood that, although individual examples may be discussed herein, the present disclosure covers all combinations of the disclosed examples, including, without limitation, the different component combinations, method step combinations, and properties of the system. It should be understood that the compositions and methods are described in terms of “comprising,” “containing,” or “including” various components or steps. The systems and methods can also “consist essentially of or “consist of the various components and steps. Moreover, the indefinite articles “a” or “an,” as used in the claims, are defined herein to mean one or more than one of the element that it introduces.

For the sake of brevity, only certain ranges are explicitly disclosed herein. However, ranges from any lower limit may be combined with any upper limit to recite a range not explicitly recited, as well as ranges from any lower limit may be combined with any other lower limit to recite a range not explicitly recited. In the same way, ranges from any upper limit may be combined with any other upper limit to recite a range not explicitly recited. Additionally, whenever a numerical range with a lower limit and an upper limit is disclosed, any number and any included range falling within the range are specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values even if not explicitly recited. Thus, every point or individual value may serve as its own lower or upper limit combined with any other point or individual value or any other lower or upper limit, to recite a range not explicitly recited.

One or more illustrative examples incorporating the examples disclosed herein are presented. Not all features of a physical implementation are described or shown in this application for the sake of clarity. Therefore, the disclosed systems and methods are well adapted to attain the ends and advantages mentioned, as well as those that are inherent therein. The particular examples disclosed above are illustrative only, as the teachings of the present disclosure may be modified and practiced in different but equivalent manners apparent to those skilled in the art having the benefit of the teachings herein. Furthermore, no limitations are intended to the details of construction or design herein shown other than as described in the claims below. It is therefore evident that the particular illustrative examples disclosed above may be altered, combined, or modified, and all such variations are considered within the scope of the present disclosure. The systems and methods illustratively disclosed herein may suitably be practiced in the absence of any element that is not specifically disclosed herein and/or any optional element disclosed herein.

Although the present disclosure and its advantages have been described in detail, it should be understood that various changes, substitutions and alterations can be made herein without departing from the spirit and scope of the disclosure as defined by the following claims.

What is claimed is:

1. A system for clarifying water, the system comprises:
a water clarifier comprising a settling tank;
a sample port disposed in a wall of the settling tank and configured to allow for the removal of a sludge sample from the settling tank;
a fluid characterization unit fluidically coupled to the sample port;
a controller coupled to the fluid characterization unit; and
a chemical additive pump coupled to the controller and the water clarifier.

2. The system of claim 1, wherein the fluid characterization unit comprises a Coriolis meter or a refractometer.

3. The system of claim 1, wherein the settling tank comprises a plurality of sample ports arranged vertically through the wall of the settling tank.

4. The system of claim 3, wherein the plurality of sample ports are configured to remove a sludge sample from a different height of a sludge bed disposed in the settling tank.

5. The system of claim 4, further comprising at least one fluid characterization unit; wherein each individual sample port is fluidically coupled to at least one fluid characterization unit.

6. The system of claim 1, wherein the fluid characterization unit is configured to measure a density of the sludge sample removed from the sample port.

7. The system of claim 6, wherein the fluid characterization unit outputs a signal corresponding to the measured density of the sludge sample to the controller.

8. The system of claim 7, wherein the controller is configurable to receive the output signal from the fluid characterization unit and then output a second signal to the chemical additive pump.

9. The system of claim 8, wherein the chemical additive pump is configurable to receive the second signal from the controller and to introduce a chemical additive into the water clarifier; wherein a volume of the introduced chemical additive is determined by the controller.

10. The system of claim 9, wherein the controller is configurable to determine the volume of the introduced chemical additive using a reference table or calibration curve based in part on the measured density of the sludge sample.

11. The system of claim 10, wherein the controller is configurable to determine the volume of chemical additive and to output the corresponding second signal to the chemical additive pump automatically and without operator input.

12. The system of claim 9, wherein the chemical additive comprises aluminum chlorohydrate, polyaluminum chloride, epichlorohydrin, polydiallyldimethylammonium chloride, sodium aluminate, ferric chloride, ferric sulfate, aluminum chloride, aluminum sulfate anionic polyacrylamide, cationic polyacrylamide, or a combination of chemical additives.

13. The system of claim 1, wherein the controller is a proportional–integral–derivative controller (PID).

14. The system of claim 1, further comprising a plurality of chemical additive pumps each configurable to introduce a different species of chemical additive into the water clarifier.

15. A method for clarifying water, the method comprises:
obtaining a sludge sample from a settling tank of a water clarifier,
measuring a density of the sludge sample, and
adjusting a volume of a chemical additive introduced into the water clarifier based at least in part on the measured density of the sludge sample.

16. The method of claim 15, wherein the density is measured with a Coriolis meter or a refractometer.

17. The method of claim 16, wherein the Coriolis meter or a refractometer outputs a signal to a controller coupled to a chemical additive pump which introduces the chemical additive into the water clarifier.

18. The method of claim 17, further comprising configuring the controller to determine the volume of the introduced chemical additive using a reference table or calibration curve based in part on the measured density of the sludge sample.

19. The method of claim 18, further comprising configuring the controller to determine the volume of chemical additive and to output a signal to the chemical additive pump automatically and without operator input.

20. The method of claim 18, wherein the introduced chemical additive adjusts a density of a sludge bed disposed in the settling tank.
